(19) United States
(12) Patent Application Publication
(10) Pub. No.: US 2011/0284783 A1
(43) Pub. Date: Nov. 24, 2011

(54) OPEN END VARIABLE BLEED SOLENOID (VBS) VALVE WITH INHERENT VISCOUS DAMPENING

(75) Inventors: William D. Haynes, Clarkston, MI (US); Matthew T. Allbert, Oxford, MS (US)

(73) Assignee: BorgWarner Inc., Auburn Hills, MI (US)

(21) Appl. No.: 13/145,803

(22) PCT Filed: Jan. 20, 2010
(86) PCT No.: PCT/US2010/021460

§ 371 Date: Jul. 22, 2011

Related U.S. Application Data
(60) Provisional application No. 61/206,068, filed on Jan. 27, 2009.

(51) Int. Cl. F16K 31/02

(52) U.S. Cl. 251/129.15

(57) ABSTRACT

A solenoid valve (10) includes a solenoid portion (24b) and a hydraulic portion (24a) having a valve housing (26) connectable to the solenoid portion (24b). A valve shaft (34) mounted in the housing (26) includes a first end positioned in the solenoid portion (24b) and a second end positioned in the hydraulic portion (24a). The valve shaft (34) includes a passage (36) disposed therethrough to allow fluid flow through the valve shaft (34). A valve (38) is located at the first end of the valve shaft (34). When the valve shaft (34) is moved in a first direction, the valve (38) moves toward a closed position, and when the valve shaft (34) is moved in a second direction, the valve (38) moves toward an open position.

### FIELD OF THE INVENTION

The present invention relates to solenoid operated hydraulic control valves.

### BACKGROUND OF THE INVENTION

The use of solenoid operated hydraulic control valves in hydraulic control systems is well-known. One application of such a valve is in an electronically controlled automatic transmission of an automobile. In an automatic transmission, a solenoid pressure control valve usually controls many critical system parameters and performance of the valve should be consistent and stable.

When the valve is used in such an application, there are many potential sources of hydraulic and/or electro-mechanical “noise” in the fluid system which can initiate or aggravate system instability by, for example, causing sympathetic harmonic vibrations in related system components. When a pressure control solenoid responds to electronic and/or hydraulic system noise by being forced into an uncontrolled vibration response, the system providing fluid to vehicle components may become unstable, and the values of the critical system parameters may fluctuate in an undesired manner. System hydraulic vibrational instabilities can create detrimental valve performance characteristics which affect vehicle performance and/or reliability. For example, destabilizing forces acting on the solenoid valve shaft may produce variations in the sizes of flow openings, resulting in irregularities in fluid flow through the valve, and also irregularities in valve output pressure.

In view of the above, a need exists for a method of damping or otherwise attenuating noise-induced forces acting on the solenoid valve.

### SUMMARY OF THE INVENTION

In one aspect of the embodiments of the present invention, a solenoid valve is provided including a solenoid portion and a hydraulic portion having a valve housing connectable to the solenoid portion. A valve shaft mounted in the housing includes a first end positioned in the solenoid portion and a second end positioned in the hydraulic portion. The valve shaft includes a passage disposed therethrough to allow fluid flow through the valve shaft. A valve is located at the first end of the valve shaft. When the valve shaft is moved in a first direction, the valve moves toward a closed position, and when the valve shaft is moved in a second direction, the valve moves toward an open position.

In another aspect of the embodiments of the present invention, a method of operating a variable bleed solenoid valve is provided. The valve includes a solenoid portion having a housing with an exhaust passage disposed through an end of the housing, and a hydraulic portion having a valve housing with a vent connected through the valve housing. A control volume is coupled to the valve housing. A valve shaft is slidably disposed through the solenoid portion and extends into the hydraulic portion. The valve shaft is movable in a first direction and a second direction opposite the first direction. The valve shaft includes an armature affixed thereto and a passage disposed therethrough to allow fluid flow through the shaft. A spring member is disposed to exert a force on the valve shaft when the valve shaft is moved in the first direction. A valve is located at a first end of the valve shaft inside of the solenoid portion. The operating method comprising the steps of energizing the solenoid portion to cause the valve shaft to slide in the first direction; simultaneously reducing the size of an opening defined by the valve through which fluid is permitted to flow, and flowing fluid through the shaft passage to provide viscous damping of the valve shaft as the valve shaft moves in the first direction; venting excess pressure from the control volume through the vent and through the valve to the exhaust passage until the valve reaches a closed position at which point pressure in the control volume is at a maximum; de-energizing the solenoid and causing the valve shaft to slide in a second direction in response to force exerted by the spring member on the shaft; simultaneously increasing the size of the opening defined by the valve through which fluid is permitted to flow, and flowing fluid through the shaft passage to provide viscous damping of the valve shaft as the valve shaft moves in the second direction; and venting excess pressure from the control volume through the vent and through the valve to the exhaust passage until the valve reaches a fully open position at which point pressure in the control volume is at a minimum.

In another aspect of the embodiments of the present invention, a method of operating a variable bleed solenoid valve is provided, The solenoid valve includes a solenoid portion having a housing with an exhaust passage disposed through an end of the housing, and a hydraulic portion having a valve housing with a vent connected through the valve housing. A control volume is coupled to the valve housing. A valve shaft is slidably disposed through the solenoid portion and extends into the hydraulic portion. The valve shaft is movable in a first direction and a second direction opposite the first direction. The valve shaft includes an armature affixed thereto and a passage disposed therethrough to allow fluid flow through the shaft. A spring member is disposed to exert a force on the valve shaft when the valve shaft is moved in the second direction. A valve is located at a first end of the valve shaft inside the solenoid portion. The method of operation comprises the steps of energizing the solenoid portion to cause the valve shaft to slide in the second direction; simultaneously increasing the size of an opening defined by the valve through which fluid is permitted to flow, and flowing fluid through the shaft passage to provide viscous damping of the valve shaft as the valve shaft moves in the second direction; venting excess pressure from the control volume through the vent and through the valve to the exhaust passage until the valve reaches a open position at which point pressure in the control volume is at a minimum; de-energizing the solenoid and causing the valve shaft to slide in the first direction in response to force exerted by the spring member on the shaft; simultaneously decreasing the size of the opening defined by the valve through which fluid is permitted to flow, and flowing fluid through the shaft passage to provide viscous damping of the valve shaft as the valve shaft moves in the first direction; and venting excess pressure from the control volume through the vent and through the valve to the exhaust passage until the valve reaches a fully closed position at which point pressure in the control volume is at a maximum.

In another aspect of the embodiments of the present invention, a method of providing a predetermined amount of viscous damping to a valve shaft movably disposed in a variable bleed solenoid valve is disclosed. The valve shaft includes a shaft passage disposed therethrough to allow fluid flow through the shaft to provide viscous damping of the valve shaft. The method includes the step of dimensioning an inner wall of the shaft passage so as to provide a predetermined wall surface area over which the fluid flows, to correspondingly provide a predetermined total force acting on the shaft due to viscous shear from fluid flow through the shaft passage.

In another aspect of the embodiments of the present invention, a pressure control valve is provided including a housing, a control port at a first end of the housing, and an exhaust port and an associated poppet valve seat at a second end of the housing. A valve shaft is mounted within the housing and includes a first end, a second end, a shaft passage extending therethrough, and a poppet located at the shaft second end. The poppet is operably associated with the valve seat and the exhaust port. The shaft first end has a first diameter and the shaft second end has a second diameter larger than the first diameter. An exterior of the shaft defines an area usable for controlling control volume pressure. This control area is defined by a difference between a cross-sectional area defined by the second diameter and a cross-sectional area defined by the first diameter. The shaft is slidably disposed between the poppet valve seat and the housing first end. A solenoid actuator including an armature is affixed to the valve shaft so as to allow for the positioning of the valve shaft with respect to the valve seat to achieve variable pressure control proportional to a current applied to the actuator, to regulate pressure to the control port. The valve shaft permits flow and pressure communication between the control port and the poppet and provides viscous dampening of the valve due to viscous shear between a surface defining the shaft passage and a fluid residing within the shaft passage.

### BRIEF DESCRIPTION OF THE DRAWINGS

FIG. 1 is a cross-sectional side view of a normally open solenoid valve in accordance with one embodiment of the present invention, in an open, or de-energized, condition.

FIG. 1A is the view in FIG. 1 showing the valve in a closed, or energized, condition.

FIG. 2 is a cross-sectional side view of a normally closed solenoid valve in accordance with one embodiment of the present invention, in a closed, or de-energized, condition.

FIG. 2A is the view in FIG. 2 showing the valve in an open, or energized, condition.

### DETAILED DESCRIPTION

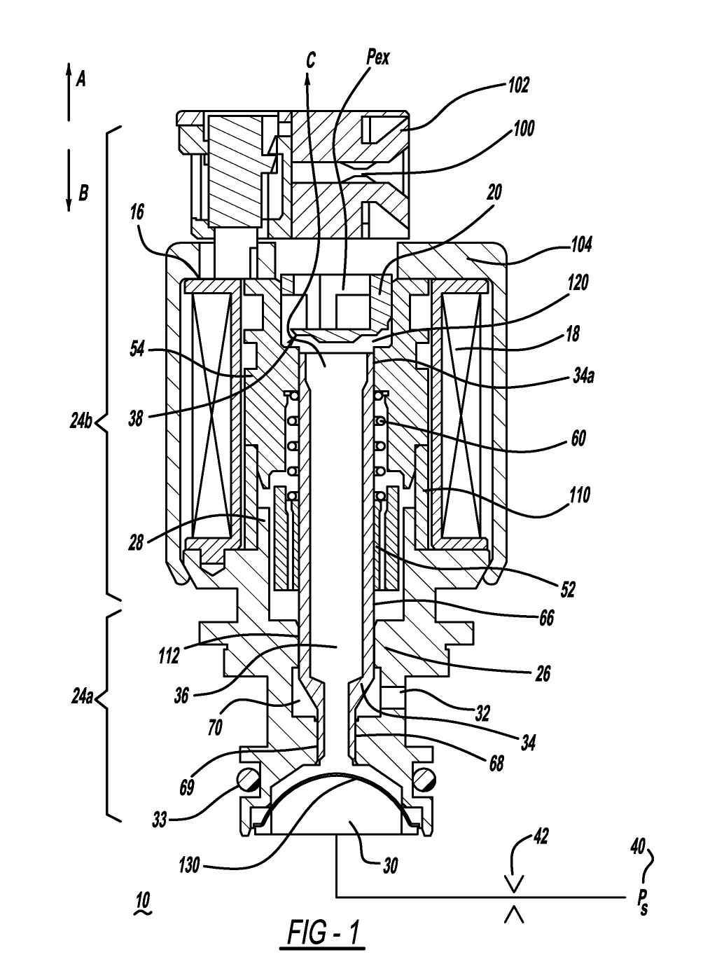

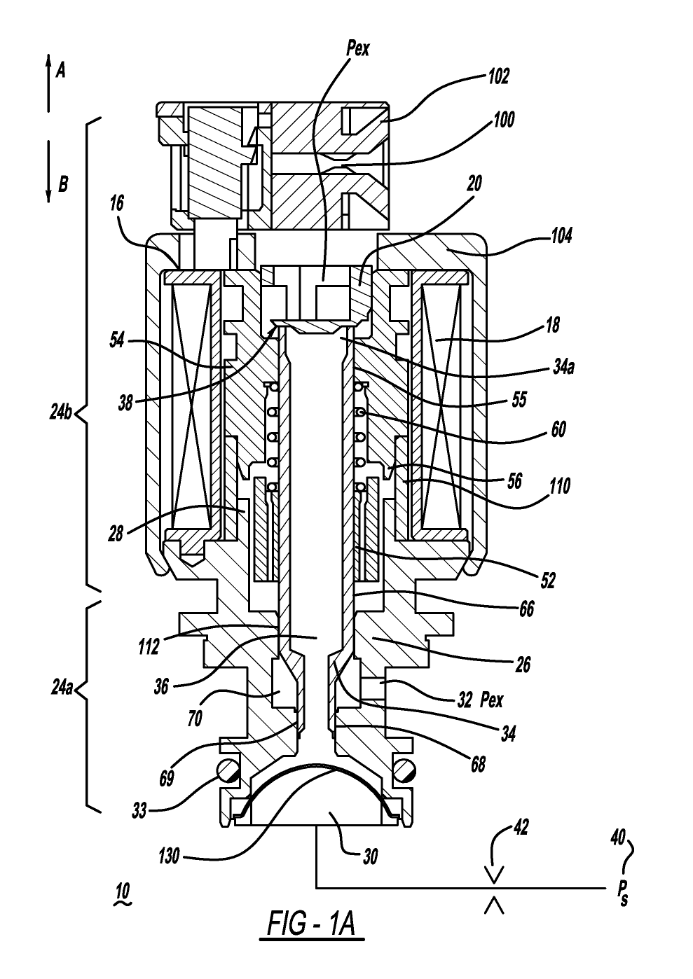

FIGS. 1 and 1A depict longitudinal cross-sectional views of a normally open, open ended variable bleed solenoid valve 10. The valve 10 has a solenoid portion 24b which includes a housing 104 that encases a bobbin 16 having a coil 18 of wire wound upon the bobbin 16.

The wire is terminated to connector blades or terminals 100 that are coupled to the bobbin. The bobbin also contains features that allow for a structural connection to a connector shroud 102 that surrounds the connector blades 100 to protect them and isolate them from the remainder of the solenoid, to aid in preventing electrical shorts. A housing 104 formed from steel or another material having a high magnetic permeability surrounds the coil 18 and bobbin 16 and serves to transfer magnetic flux to the other portions of the magnetic circuit when the solenoid valve is energized. When the coil 18 is energized there is a magnetic field generated in the solenoid portion 24b. The solenoid portion 24b also has a valve seat 20 defining an exhaust port.

The valve 10 also has a hydraulic portion 24a that includes a valve housing 26 connectable to the solenoid portion 24b. Valve housing 26 contains features that interface with a bore (not shown) that the solenoid valve mates to. The valve housing also has features that provide a journal bearing surface 69 for facilitating movement of a valve shaft 34 (described below) and an armature 52 (also described below) within the valve housing. In order to facilitate the movement of the valve shaft 34, armature 52 is annularly disposed about and affixed, such as being press fit, glued, soldered, welded, or otherwise suitably affixed to the valve shaft 34. A flux tube portion 28 of the valve housing 26 slides into the solenoid portion 24b adjacent both the bobbin 16 and an alignment tube 110 (described below). The bearing surfaces in the valve housing are aligned with the bearing surfaces in the flux tube by an alignment tube 110.

In order to achieve the desired proportional magnetic function, a pole piece 54 is disposed in the solenoid portion 12 located adjacent to a portion of the bobbin 16. In the embodiment shown in FIGS. 1 and 1A, the pole piece 54 has a reduced inner diameter flange 56 which is configured to overlap the armature 52. The overlapping flange 56 causes the desired magnetic characteristic (magnetic force vs. displacement of the armature 52 and shaft 34) to be achieved because the geometry of the flange 56 affects the distribution of the magnetic field generated by the energized coil 18. Valve seat 20 is affixed to pole piece 54 using an interference fit or other suitable method. The axial position of the valve seat 20 determines the starting position of the valve shaft and armature relative to the pole piece 54, which will shape the characteristic pressure and leakage output response of the solenoid valve. The pole piece 54 has features that provide a journal bearing surface 55 for valve shaft 34 and armature 52 to move within the flux tube.

The hydraulic portion 24a also includes a control volume 30 at a pressure P_{C} that is located at an end of the valve housing 26 opposite the solenoid portion 24b. As seen in FIGS. 1 and 1A, a supply port 40 and a feed orifice 42 are also incorporated into the fluid control system, and may or may not be incorporated into the variable bleed solenoid valve itself. At least one vent 32 is provided in fluid communication with a cavity 70 residing on a side of journal bearing surface 69 opposite from control pressure region 30. Due to pressure in control pressure region 30, there is a certain amount of fluid leakage along the shaft through the clearance between journal bearing region 68 and the valve shaft, and into the cavity 70. This leakage produces a pressure in cavity 70 which, if not vented, may increase to a point where the pressure acts on the valve shaft larger diameter portion 66 to appreciably alter the force balance on the shaft, possibly affecting the control volume pressure. Vent 32 aids in preventing a buildup of pressure in cavity 70. In the embodiment shown in FIGS. 1 and 1A, the valve housing 26 is mated to an external bore (not shown) and an O-ring seal 33 separates the control pressure region P_{C} from the exhaust region Pₑₓ which is at sump pressure.

A valve shaft or pin 34 is slidably disposed through the solenoid portion 24b and extends longitudinally into the hydraulic portion 24a. The valve shaft 34 is hollow and defines a passage 36 extending through a longitudinal axis of the shaft. The passage 36 allows the flow therethrough of fluid medium from the hydraulic portion 24a to the solenoid portion 24b and then out of the valve shaft at an opposite end 34a of the shaft. Additionally, in a manner described below, the passage 36 may serve the purpose of damping the movement of the valve shaft 34, thus improving the stability of the solenoid valve 10. In the embodiment shown in FIGS. 1 and 1A, valve shaft 34 also has a relatively larger diameter portion 66 and a smaller diameter portion 68.

The passage 36 has a first end that terminates at a valve 38 located within the solenoid portion 24b. In the embodiment show in FIGS. 1 and 1A. the valve 38 includes a poppet that is formed about the end 34a of the valve shaft 34, and valve seat 20. Together the shaft end 34a and the valve seat 20 form the valve 38 which is opened and closed by the sliding of the valve shaft 34 along its longitudinal axis. A filter 130 is provided for filtering the hydraulic fluid entering the valve shaft 34.

Referring again to FIGS. 1 and 1A, in operation, the solenoid valve 10 functions in response to the energization of the solenoid portion 12. When the coil 18 is energized, the valve shaft 34 will slide in a first direction (indicated by arrow “A”) along its longitudinal axis. The armature 52 is affected by the magnetic flux generated as a result of energization of the coil 18. Coil energization produces a magnetic force on the valve shaft 34 in direction “A” that is proportional to the amount of current flowing through the coil 18 in the solenoid portion 12. When the solenoid portion 12 is energized, the valve shaft 34 will slide in a direction indicated by arrow “A” toward the valve seat 20 so that the shaft end 34a will restrict flow through the valve 38. Control volume pressure P_{C} will build until that pressure multiplied by an area defined by the difference between a cross-sectional area defined by larger diameter shaft portion 66 and a cross-sectional area defined by smaller diameter portion 68 is equal to the magnetic force. This process can continue until the solenoid is filly energized, or until the valve shaft and armature subassembly reaches its maximum allowed stroke. At this point, the control pressure will be at a maximum.

In the embodiment shown in FIGS. 1 and 1A, when the coil 18 of the solenoid portion 24b is de-energized a spring 60 will cause the armature 52 to slide in a second direction (indicated by arrow “B”) opposite the movement of the armature 52 when the coil is energized. In the embodiment shown in FIGS. 1 and 1A, the spring 60 is disposed between the armature 52 and the pole piece 54. When the solenoid portion 24b is de-energized, the spring 60 will exert force against the armature 52 to cause the valve shaft 34 to move in direction “B” until the pin-and-armature sub-assembly comes to rest against a hard stop formed by interengaging features of the shaft and the valve housing. Simultaneously, the valve 38 will move to the fully opened position as the shaft end 34a moves away from the valve seat 20 to provide an opening 120 between shaft end 34a and valve seat 20 (see FIG. 1A) through which fluid flows, as indicated by arrow “C”. Thus, fluid flows from supply port 40 through feed orifice 42, through the control volume 30, through filter 130 into the valve shaft, through the valve shaft, and out of the valve shaft to sump through opening 120. When the normally open solenoid valve is fully de-energized, this will provide the largest opening for fluid to leak out of the control volume, thereby reducing control volume pressure. Consequently, the control volume pressure will be at a minimum.

In the embodiment shown in FIG. 1, the diameter of shaft 34 “necks down” along a transition region of the shaft from a relatively larger diameter portion 66 to a relatively smaller diameter portion 68 prior to the shaft entering journal bearing region 69, which is formed by a portion of valve housing 26. In this embodiment, an effective hard stop feature is formed when the transition region of the shaft abuts the journal bearing region 69. However, any of a variety of other structural features of the shaft and/or the housing may be located, utilized, and/or specially incorporated into the shaft and/or housing to provide such a hard stop feature.

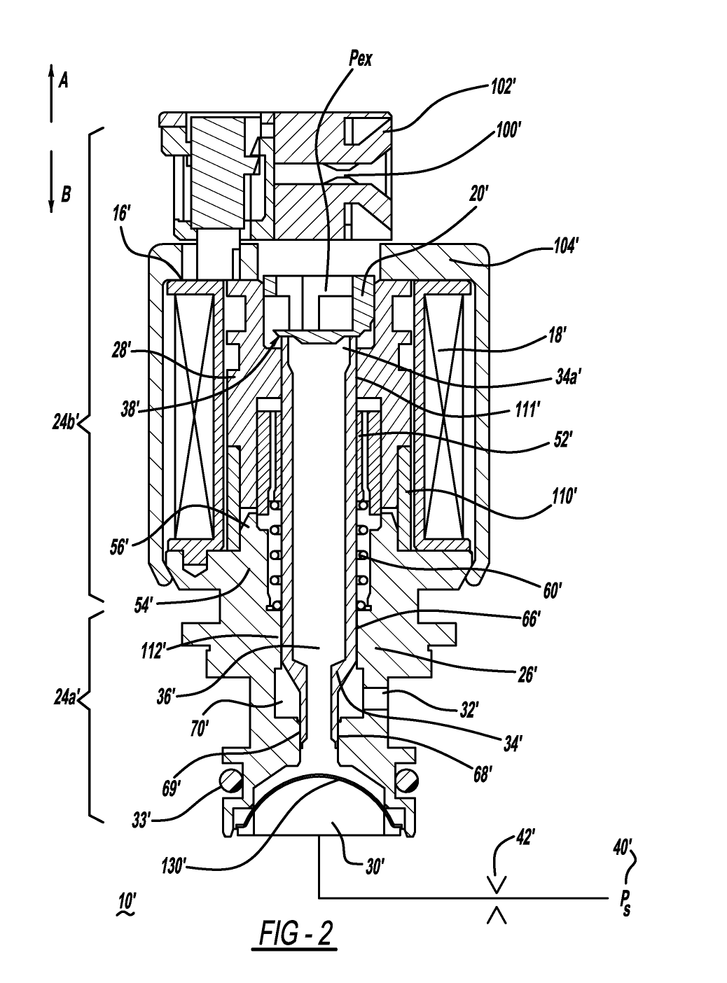

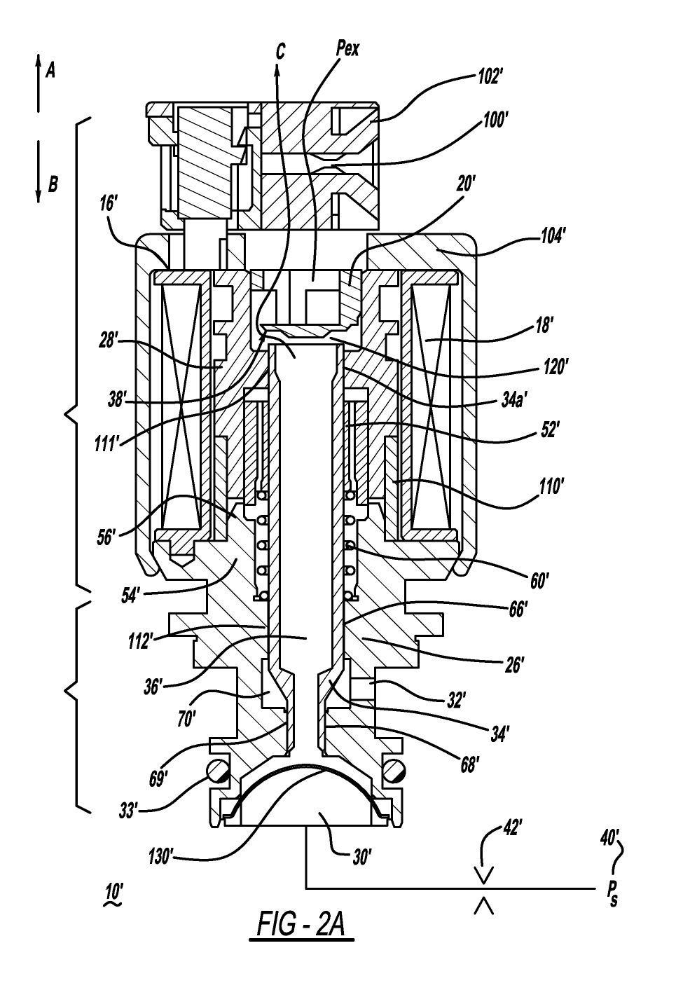

FIGS. 2 and 2A depict a cross-sectional view of a normally closed valve configuration, in accordance with another embodiment of the present invention. The embodiment shown in FIG. 2 differs from the embodiment shown in FIGS. 1 and 1A with respect to the positioning of the pole piece 54′, flux tube 28′, spring 60′and armature 52′. FIG. 2 shows a pole piece 54′ that is part of the valve housing 26′. The pole piece 54′ has an inner portion 56′ that is configured to overlap the armature 52′ for shaping magnetic characteristics the armature 52′. A spring 60′ is disposed between the armature 52′ and valve housing 26′ A portion 111′ of flux tube 28′ is sized to form a conduit through which shaft 34′ passes and which acts as a bearing surface along which the valve shaft 34 slides. Spring 60′ biases the valve shaft 34′ and armature 52′ towards the valve seat 20′ where, the pin and armature sub-assembly comes to equilibrium against that spring load.

The operation of the embodiment shown in FIGS. 2 and 2A is similar to the embodiment depicted in FIGS. 1 and 1A with the exception that when the solenoid portion 24b′ is energized, the valve 38′ will be opened, whereas in FIGS. 1 and 1A when the solenoid portion 24b becomes energized the valve 38 will be urged toward a closed position.

Referring to FIGS. 2 and 2A, in this particular embodiment of the invention, when the solenoid portion 24b′ is energized, the armature 52′ will move in the direction indicated by arrow “B”, hereby opening the valve 38′ as the end portion 34a′ of shaft 34′ moves away from the valve seat 20. This provides an opening 120′ (see FIG. 2A) between shaft end 34a′ and valve seat 20′ through which fluid flows, as indicated by arrow “C”. Thus, fluid flows from the supply port 40′ through feed orifice 42′, through control volume 30, then through filter 130′ into the valve shaft 34′, through the valve shaft, and out of the valve shaft to sump through opening 120′. As more current is applied to the solenoid, the size of opening 120′ between shaft end 34a′ and valve seat 20′ increases, thereby enabling a greater flow rate of fluid through opening 120′ and reducing pressure in the control volume. This process will continue until the maximum current is supplied to the solenoid, or until the valve shaft and armature sub-assembly reaches its maximum allowed stroke. Thus, when the normally closed solenoid valve is fully energized, the largest opening is provided for fluid to leak out of the control volume, thereby reducing control volume pressure. Consequently, the control volume pressure will be at a minimum.

In the de-energized state, no current is applied to the solenoid. When the solenoid portion 24b′ is de-energized, the spring 60′ will exert force against the armature 52′ and cause the valve shaft 34′ to slide in the direction indicated by arrow “A” so that the valve 38 becomes closed as shaft end 34a′ comes into contact with the valve seat 20′. The embodiment shown in FIGS. 2 and 2A is referred to as a normally closed valve since the valve 38′ is in the closed position when the solenoid portion 24b′ is de-energized. Consequently, in the de-energized state, the control pressure will be at a maximum.

In the embodiments of the present invention described herein, hydraulic fluid travels into the hollow valve shaft through filter 130 (or 130′), through the hollow valve shaft, then through the opening 120 (or 120′) formed between the valve seat and the valve shaft. Forces that would act to promote instability in the solenoid valve by moving the valve shaft must overcome the damping effect provided by viscous shear between the fluid volume in the hollow valve shaft and the inside surface or inner wall of the valve shaft. Thus, the structure of the valve shaft is used to provide a damping effect. This damping effect may be controlled to some degree by increasing or decreasing the surface area of the inner wall of the valve shaft (for example, by increasing or decreasing the shaft inner diameter), thereby increasing the surface area over which the shear forces act.

It may be seen from the above description that whenever there is a fluid under pressure in the control volume region 30, there will be fluid residing within valve shaft passage 36. Thus, any movement of the valve shaft will be dampened by viscous shear occurring between the fluid column in passage 36 and the inner walls of the shaft which define the passage, and this dampening characteristic of the valve is present during any operation of the valve.

It should be understood that the preceding is merely a detailed description of various embodiments of this invention and that numerous changes to the disclosed embodiments can be made in accordance with the disclosure herein without departing from the spirit or scope of the invention. The preceding description, therefore, is not meant to limit the scope of the invention.

What is claimed is:

1. A solenoid valve comprising:
a solenoid portion;
a hydraulic portion having a valve housing connectable to the solenoid portion;
a valve shaft including a first end positioned in the solenoid portion and a second end positioned in the hydraulic portion, the valve shaft including a passage disposed therethrough to allow fluid flow through the valve shaft; and
a valve located at the first end of the valve shaft,
wherein when the valve shaft is moved in a first direction, the valve moves toward a closed position and when the valve shaft is moved in a second direction the valve moves toward an open position.

2. The solenoid valve of claim 1 further comprising a supply port connected through the valve housing of the hydraulic portion.

3. The solenoid valve of claim 2 wherein the shaft passage enables viscous shear between fluid residing in the shaft passage and a surface defining the shaft passage, thereby providing viscous dampening of the valve shaft to improve the stability of the solenoid valve.

4. The solenoid valve of claim 1 wherein the solenoid portion has a housing and wherein the valve comprises a poppet formed about the first end of the valve shaft and a valve seat formed in the solenoid housing.

5. The solenoid valve of claim 1 wherein the solenoid housing encases a bobbin with a coil wound thereon and the valve shaft includes an armature slidably disposed through the solenoid portion, the solenoid valve further comprising a pole piece annularly disposed in the solenoid portion adjacent the bobbin, wherein the pole piece has a flange configured to align with and slidably circumscribe the armature, wherein the armature is circumscribed by the bobbin and coil so that the armature and the valve shaft slide about a longitudinal axis of the valve shaft in response to the energization of the solenoid portion.

6. The solenoid valve of claim 5 further comprising a spring configured about the valve shaft and extending between the armature and the solenoid housing, wherein when the solenoid portion is de-energized, the spring applies force to the armature to slide the valve shaft so that the valve is in the open position.

7. The solenoid valve of claim 5 further comprising a spring configured about the valve shaft and extending between the armature and the valve housing, wherein when the solenoid portion is de-energized, the spring applies force to the armature to slide the valve shaft so the valve is in the closed position.

8. A method of operating a variable bleed solenoid valve including a solenoid portion having a housing with an exhaust passage disposed through an end of the housing, a hydraulic portion coupled to the solenoid portion and including having a valve housing with a vent connected through the valve housing, a control volume coupled to the valve housing, a valve shaft slidably disposed through the solenoid portion and extending into the hydraulic portion, the valve shaft being movable in a first direction and a second direction opposite the first direction, the valve shaft including a shaft passage disposed therethrough to allow fluid flow through the shaft, a spring member disposed to exert a force on the valve shaft when the valve shaft is moved in the first direction, and a valve located at a first end of the valve shaft inside of the solenoid portion, the method comprising the steps of
energizing the solenoid portion to cause the valve shaft to slide in the first direction;
simultaneously reducing the size of an opening defined by the valve through which fluid is permitted to flow, and flowing fluid through the shaft passage to provide viscous damping of the valve shaft as the valve shaft moves in the first direction;
venting excess pressure from the control volume through the vent and through the valve to the exhaust passage until the valve reaches a closed position at which point pressure in the control volume is at a maximum;
de-energizing the solenoid and causing the valve shaft to slide in the second direction in response to force exerted by the spring member on the shaft;
simultaneously increasing the size of the opening defined by the valve through which fluid is permitted to flow, and flowing fluid through the shaft passage to provide viscous damping of the valve shaft as the valve shaft moves in the second direction; and
venting excess pressure from the control volume through the vent and through the valve to the exhaust passage until the valve reaches a fully open position at which point pressure in the control volume is at a minimum.

9. The method of claim 8 further comprising the step of providing a predetermined amount of viscous damping of the valve shaft by dimensioning an inner wall of the shaft passage so as to provide a predetermined wall surface area over which the fluid flows, to correspondingly provide a predetermined total force acting on the shaft from viscous shear due to fluid flow through the shaft passage.

10. The solenoid valve of claim 1 wherein an inner wall of the shaft passage is dimensioned so as to provide a predetermined inner wall surface area over which the fluid flows, to correspondingly provide a predetermined total force acting on the shaft due to viscous shear from fluid flow through the shaft passage, thereby viscously dampening movement of the valve shaft.

11. A pressure control valve comprising:
a housing;
a control port at a first end of the housing;
an exhaust port and an associated poppet valve seat at a second end of the housing;
a valve shaft including a first end, a second end, a shaft passage extending therethrough, and a poppet located at the shaft second end, the poppet being operably associated with the valve seat and the exhaust port, the shaft first end having a first diameter and the shaft second end having a second diameter larger than the first diameter, an exterior of the shaft defining an area usable for controlling control volume pressure, the area being defined by a difference between a cross-sectional area defined by the second diameter and a cross-sectional area defined by the first diameter, the shaft being slidably disposed between the poppet valve seat and the housing first end; and
a solenoid actuator including an armature affixed to the valve shaft so as to allow for the positioning of the valve shaft with respect to the valve seat to achieve variable pressure control proportional to a current applied to the actuator, to regulate pressure to the control port,
wherein the shaft permits flow and pressure communication between the control port and the poppet and provides viscous dampening of the valve due to viscous shear between a surface defining the shaft passage and a fluid residing within the shaft passage.

12. The valve of claim 11 further comprising an adjustable end cap disposed through the housing of the solenoid, wherein the exhaust port is disposed about the end cap.

13. The valve of claim 11 further comprising a spring configured about the hollow valve shaft, wherein the spring is biased to move the valve shaft in a direction to contact the stop placing the solenoid valve in a normally open or normally low pressure position when de-energized.

14. The valve of claim 11 further comprising a spring configured about the hollow valve shaft, wherein the spring is biased to move the primary poppet in a direction to contact the primary valve seat, placing the valve in a normally closed or normally high pressure position when de-energized.

15. The valve of claim 11 further comprising a bearing supporting the valve shaft, the bearing being configured for minimizing a transfer of contamination suspended with the fluid to working air gaps of formed within the actuator.
